(19) United States
(12) Patent Application Publication
(10) Pub. No.: US 2009/0115656 A1
(43) Pub. Date: May 7, 2009

(54) Systems and Methods for Global Differential Positioning

(75) Inventors: Sundar Raman, Fremont, CA (US); Lionel Garin, Palo Alto, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SIRF TECHNOLOGY, INC., San Jose, CA (US)

(21) Appl. No.: 11/935,617

(22) Filed: Nov. 6, 2007

(51) Int. Cl. G01S 1/00; G01S 5/00

(52) U.S. Cl. 342/357.03

(57) ABSTRACT

Systems and methods for global differential positioning are provided. In this regard, a representative system, among others, may include a first receiver being configured to receive global correction data from a single source; and a computing device being configured to adjust positional estimates based on the received global correction data. A representative method, among others, for global differential positioning may include receiving satellite measurement information; receiving global correction data from a single source; generating location information based on the received satellite information; adjusting the location information based on the global correction data to produce adjusted location information; and delivering the adjusted location information.

### TECHNICAL FIELD

The present disclosure is generally related to signal processing and, more particularly, is related to systems and methods for global differential positioning.

### BACKGROUND

Typically, a global positioning system (GPS) can provide a user with a position, velocity, and time (PVT) solution, sometimes referred to as a navigation solution. The global positioning system may include a GPS receiver, which typically incorporates current measurements from four or more satellites to update its most recent PVT solution. The GPS receiver can incorporate dead reckoning techniques that estimate a vehicle's acceleration to propagate the current PVT solution in-between measurement updates. Differential GPS (DGPS) is used to improve the accuracy of GPS. The improvement in accuracy arises because certain sources of GPS errors vary slowly with time and are strongly correlated over distance.

For instance, error components due to incorrect ephemeris data, satellite clock, ionosphere, and troposphere data can be accurately estimated and cancelled using a reference receiver at a known location. However, even these nominally correlated errors lose that correlation if they are significantly delayed or are applied to a receiver significantly separated from the reference station. The performance of DGPS receivers degrades with the distance from the reference receivers.

### SUMMARY

Systems and methods for global differential positioning are provided. In this regard, a representative system, among others, includes a first receiver being configured to receive global correction data from a single source; and a computing device being configured to adjust positional estimates based on the received global correction data.

A representative method, among others, for global differential positioning includes receiving satellite measurement information; receiving global correction data from a single source; generating location information based on the received satellite information; adjusting the location information based on the global correction data to produce adjusted location information; and delivering the adjusted location information.

An alternative method for global differential positioning includes receiving global correction data from a single source; receiving position and velocity estimates from a GPS receiver; summing the global correction data and the position and velocity estimates from the GPS receiver to produce summation data; determining location information using the summation data; and delivering the location information.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram that illustrates a system overview for determining a location of a navigation receiver.

FIG. 2 is a block diagram that illustrates an embodiment of subsystems of a navigation receiver, such as that shown in FIG. 1.

FIG. 3 is a block diagram that illustrates an embodiment of a navigation receiver, such as that shown in FIG. 1.

FIG. 4 is a block diagram of a local differential GPS system.

FIG. 5 is a block diagram that illustrates an embodiment of a local differential navigation receiver, such as that shown in FIG. 4.

FIG. 6 is a block diagram of a global differential GPS system.

FIG. 7 is a block diagram that illustrates an embodiment of a global differential navigation receiver, such as that shown in FIG. 6.

FIG. 8 is a flow diagram that illustrates an embodiment of a method for global differential positioning using the navigation receiver of FIG. 7.

FIG. 9 is a flow diagram that illustrates an alternative embodiment of a method for global differential positioning using the navigation receiver of FIG. 7.

FIG. 10 is a block diagram that illustrates an embodiment of a global differential navigation receiver, such as that shown in FIG. 6.

FIG. 11 is a hardware block diagram of a general-purpose computing device that can be used to implement one or more of the components of a navigation receiver, such as that shown in FIGS. 3, 5, and 7.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a GPS receiver adjusts for errors determined from a global reference. Some methods of adjusting for errors are provided in U.S. patent application Ser. No. 10/959,497 entitled “Method and System for a Data Interface For Aiding a Satellite Positioning System Receiver;” U.S. Pat. No. 5,552,794 entitled “Position Estimation Using Satellite Range Rate Measurements;” and U.S. Pat. No. 6,453,238 entitled “Navigation System and Method for Tracking the Position of an Object,” which are hereby incorporated by reference.

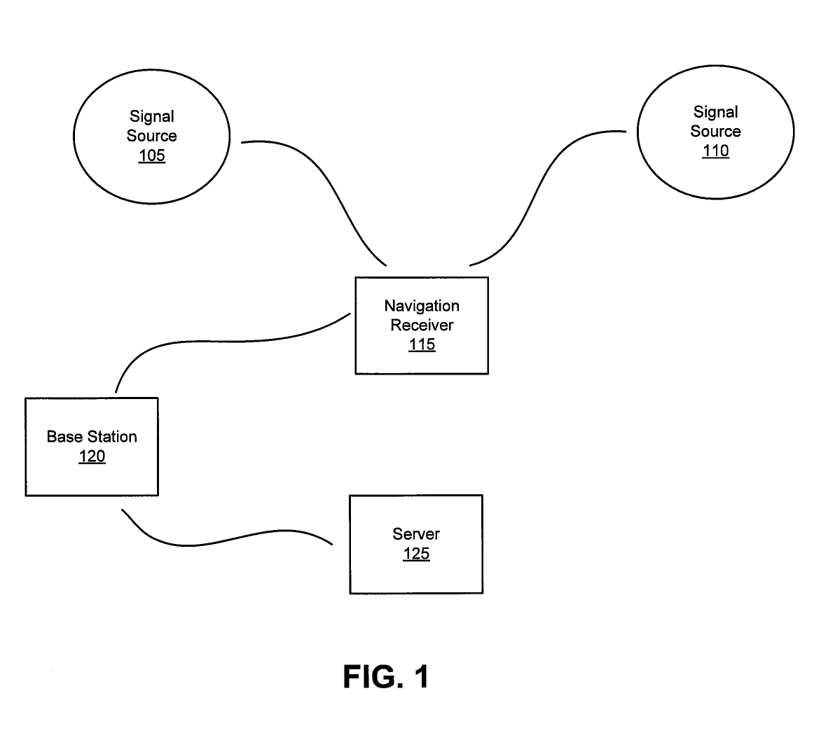

FIG. 1 is a block diagram that illustrates a system overview for determining a location of a navigation receiver 115. A simple system 100 comprises a plurality of signal sources 105, 110 and a navigation receiver 115. Alternatively or additionally, a more complex system 100, such as an assisted global positioning system (GPS), further comprises a base station 120 and a server 125. Although only one navigation receiver 115, one base station 120, and one server 125 are shown in system 100, the system 100 can include multiple navigation receivers, multiple base stations and/or multiple servers. Alternatively or additionally, the server 125 may be co-located with the base station 120 or with the navigation receiver 115.

The signal sources 105, 110 include GPS satellites, among others. The signal sources 105, 110 generally orbit above the location of the receivers 115 at any given time. The navigation receivers 115 include, but are not limited to, GPS receivers, cell phones with embedded signal receivers, and Personal Digital Assistants (PDAs) with embedded signal receivers, among others. The signal sources 105, 110 transmit signals to the navigation receivers 115, which use the signals to determine the location, speed, and direction of the navigation receivers 115.

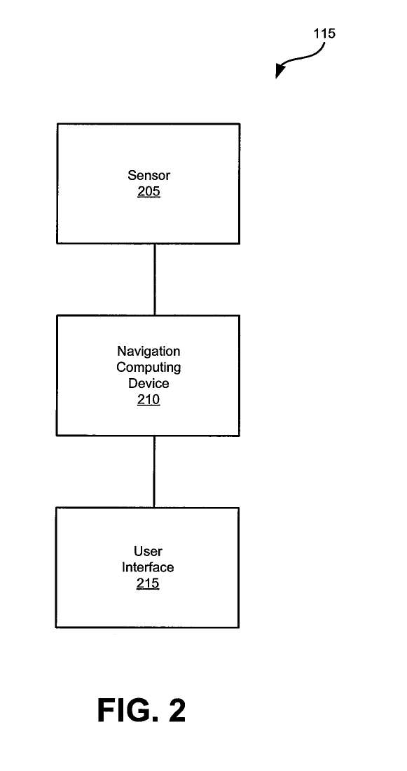

FIG. 2 is a block diagram that illustrates an embodiment of subsystems of a navigation receiver 115, such as that shown in FIG. 1. The navigation receiver 115 may include sensor(s) 205 and a navigation computing device 210. The sensor 205 can include, but is not limited to, inertial sensors that include, for example, micro-electromechanical system (MEMS) sensors, such as, for example, accelerometers and gyroscopes, among others. In general, accelerometers measure acceleration of their own motion. The accelerometer detects specific forces, which include gravity and vehicle acceleration. A gyroscope measures orientation or angular rate based on the principle of conservation of angular momentum and detection of Coriolis acceleration. The gyroscope detects the angular rate of turn for a defined axis (roll, pitch or heading). In general, the sensor 205 can detect the difference between the moving and stationary vibrations of a vehicle. In particular, the sensor 205 can detect the acceleration and/or the angular rate of the vehicle and generate a vehicle vibration profile based on the detected acceleration and/or the detected angular rate.

Various combinations of accelerometer measurement data, gyroscope measurement data, and GPS velocity data can be used to determine if the vehicle is stationary at any particular instance. The various combinations can further reduce the probability of false detection (Pfd) to nearly zero percent and keep the probability of detection (Pd) close to 100%. Pfd is defined as the probability of events that the algorithm declares that the vehicle is in static condition when the vehicle is actually moving. Pd is the probability of the event that the algorithm declares the static condition when the vehicle is actually stationary.

The navigation computing device 210 can include, but is not limited to, a GPS receiver, among others. The navigation receiver 115 can utilize the sensors 205 and the GPS receiver to sense movement of the vehicle. The navigation computing device 210 can use data generated by the sensors 205 in dead reckoning calculations to produce positioning information during periods of GPS outages. The positioning information may include data related to the position, velocity, and attitude of a vehicle. In general, dead reckoning refers to a process of calculating location by integrating measured increments of distance and direction of travel relative to a known location. The navigation computing device 210 can further include an extended Kalman filter (EKF), which estimates position, velocity, attitude, and accelerometer and gyro errors in three dimensions, such as, for example, the position (X, Y, and Z) and velocity (Vx, Vy, and Vz) of the vehicle, among others. The estimated information is passed to a user interface 215 that provides a user with navigational information.

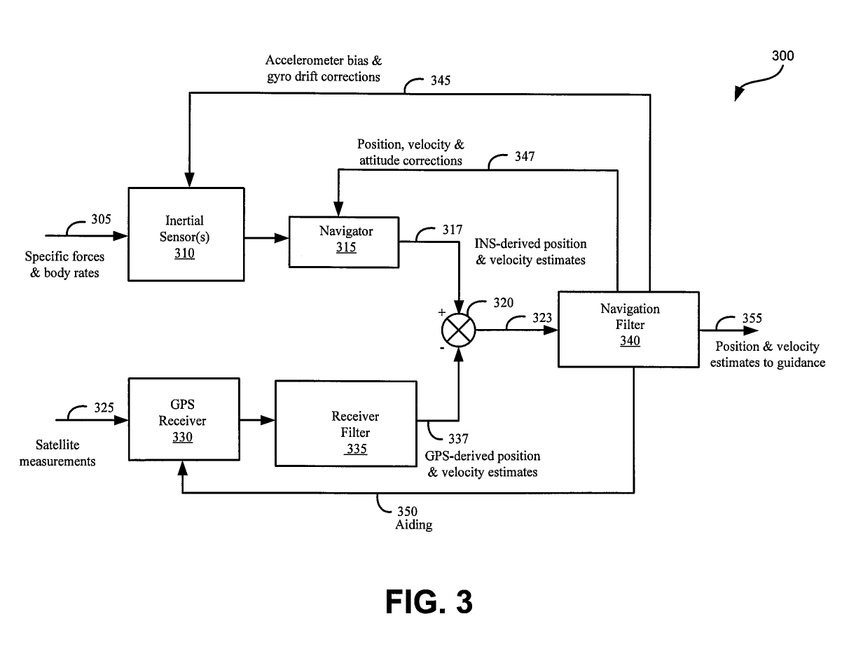

FIG. 3 is a block diagram that illustrates an embodiment of a navigation receiver, such as that shown in FIG. 1. The navigation receiver 300 may include inertial sensors 310 operative to detect specific forces and body rates 305. The inertial sensor 310 may include, but is not limited to, micro-electromechanical systems (MEMS) accelerometer, geophones and gyros, among others. The inertial sensors 310 transmit data related to the detected specific forces and body rates 305 to a navigator 315, which estimates an inertial navigational system (INS)-derived position and velocity of a vehicle based on the transmitted data. The navigator 315 transmits data 317 related to the estimated INS-derived position and velocity to a mixer 320.

Satellite measurements 325 are received by a GPS receiver 330, which transmits data related to the satellite measurements 325 to a receiver filter 335. The receiver filter 335 may include, but is not limited to, a GPS receiver Kalman filter, among others. The filter 335 estimates a GPS-derived position and velocity of the vehicle based on the satellite measurements 325, and transmits the estimated data 337 to the mixer 320. The mixer 320 mixes the data 317, 337 related to both the INS and GPS-derived positions and velocities, and transmits the mixed data 323 to a navigation filter 340.

The navigation filter 340 can include, but not limited to, a navigation Kalman filter, among others. The navigation filter 340 can generate and transmit feedback information relating to an accelerometer and gyro drift correction 345; position, velocity, and attitude corrections 347; and aiding information 350 to the inertial sensors 310, the navigator 315, and the GPS receiver 330, respectively. The inertial sensor 310 can use the information related to accelerometer and gyro drift correction for calibration of the inertial sensor 310, leading to better inertial measurement. The navigator 315 can use the information related to position, velocity, and attitude corrections for more accurate positioning, velocity, and attitude calculations.

Inertial sensor data can be used to aid the satellite signal acquisition process. The GPS receiver 330 can include code-tracking loops that can be provided with inertial sensor information to improve the ability of the GPS receiver 330 to track signals in noisy environment. Additionally, if the inertial sensors 310 detect that the vehicle is stationary, measurement updates for the GPS Kalman filter 335 can utilize information relating to the vehicle static condition to improve a measurement process noise model. The navigation filter 340 generates data 355 related to position and velocity estimates to guidance based on the mixed data 323.

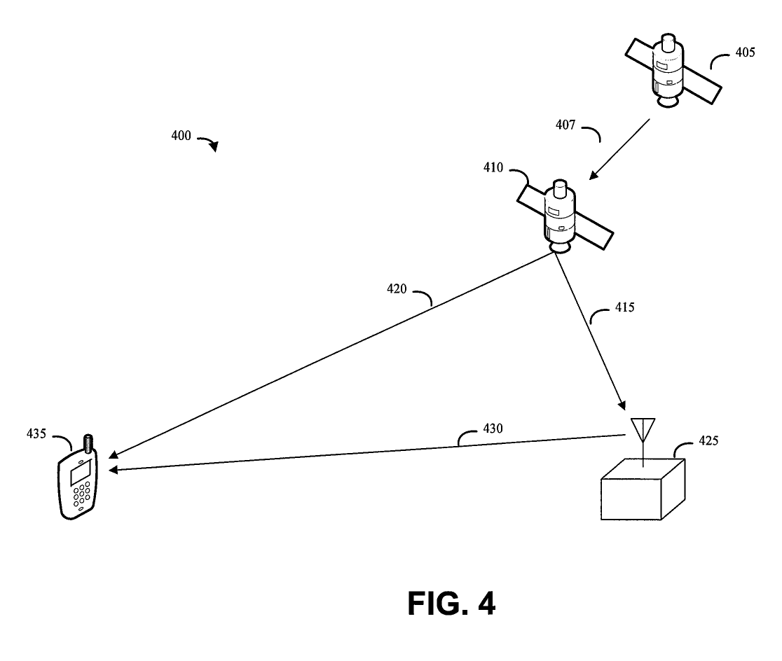

FIG. 4 is a block diagram that illustrates an embodiment of a local differential navigation system 400. An exemplary embodiment of local differential navigation system 400 may include satellite 405 (410), reference receiver 425, and GPS device 435. Satellite 405 corresponds to the true position of the satellite. However, due to satellite state errors 407, which include satellite orbit corrections, satellite clock corrections and ionosphere delay grid corrections, among others, satellite 410 corresponds to the broadcast position of the satellite. Although only one satellite 405 (410) is pictured in local differential navigation system 400, local differential navigation system 400 may include a plurality of satellites.

The position of the satellite is transmitted to reference receiver 425 with transmission signal 415 and to GPS device 435 with transmission signal 420. Both transmission signals 415, 420 include errors such as a non-limiting example of an ionosphere delay. Reference receiver 425 is at a known location. In an exemplary embodiment, the known location of reference receiver 425 is fixed, but it may be movable in other embodiments. Although only one reference receiver 425 is pictured in local differential navigation system 400, local differential navigation system 400 may include a plurality of satellites. GPS device 435 also receives a measured scalar correction signal 430 from reference receiver 425, and computes the location of GPS device 435 by using the position of the satellite received on transmission signal 420 and the measured scalar correction signal 430.

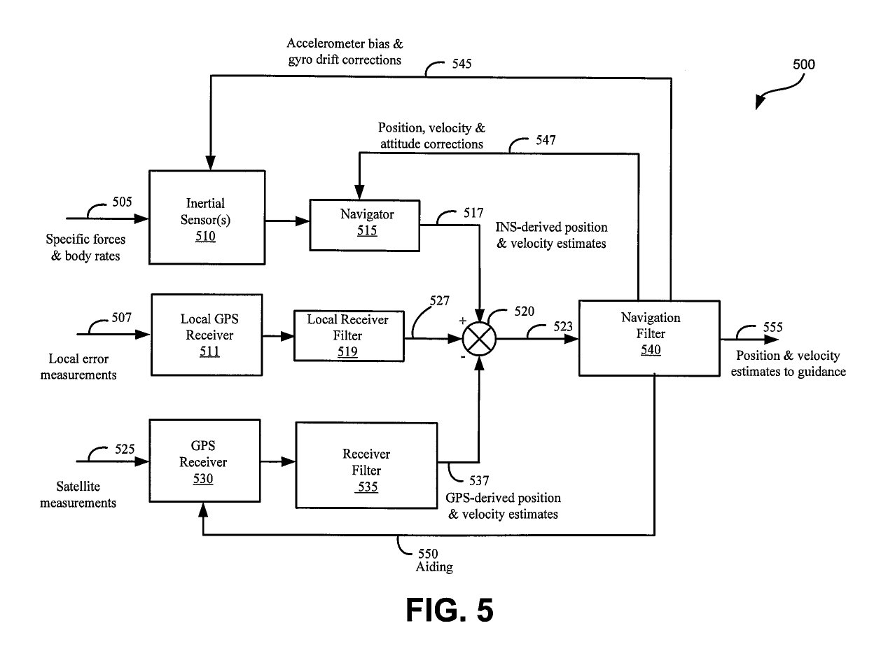

FIG. 5 is a block diagram that illustrates an embodiment of a local differential navigation receiver. The navigation receiver 500 may include inertial sensors 510 operative to detect specific forces and body rates 505. Inertial sensors 510 may include, as non-limiting examples, micro-electromechanical systems (MEMS) accelerometer, geophones and gyros, among others. The inertial sensors 510 transmit data related to the detected specific forces and body rates 505 to a navigator 515, which estimates an inertial navigational system (INS)-derived position and velocity of a vehicle based on the transmitted data. The navigator 515 transmits data 517 related to the estimated INS-derived position and velocity to a mixer 520.

Satellite measurements 525 are received by a GPS receiver 530, which transmits data related to the satellite measurements 525 to a receiver filter 535. The receiver filter 535 may include, but is not limited to, a GPS receiver Kalman filter, among others. The filter 535 estimates a GPS-derived position and velocity of the vehicle based on the satellite measurements 525, and transmits the estimated data 537 to the mixer 520.

Local error measurements 507 are received by local GPS receiver 511, which transmits data related to locally measured correction data to the local receiver filter 519. Local receiver filter 519 may include, but is not limited to, a GPS receiver Kalman filter, among others. Local receiver filter 519 estimates error calculations of GPS-derived position and velocity of the vehicle based on the local error measure measurements 507, and transmits the estimated data 527 to the mixer 520.

The mixer 520 mixes the data 517, 527, 537 related to the INS and GPS-derived positions and velocities, and the locally derived error calculations and transmits the mixed data 523 to a navigation filter 540. The navigation filter 540 can include, but not limited to, a navigation Kalman filter, among others. The navigation filter 540 can generate and transmit feedback information relating to an accelerometer and gyro drift correction 545; position, velocity, and attitude corrections 547; and aiding information 550 to the inertial sensors 510, the navigator 515, and the GPS receiver 530, respectively. The inertial sensor 510 can use the information related to accelerometer and gyro drift correction for calibration of the inertial sensor 510, leading to better inertial measurement. The navigator 515 can use the information related to position, velocity, and attitude corrections for more accurate positioning, velocity, and attitude calculations.

Inertial sensor data can be used to aid the satellite signal acquisition process. The GPS receiver 530 can include code-tracking loops that can be provided with inertial sensor information to improve the ability of the GPS receiver 530 to track signals in noisy environment. Additionally, if the inertial sensors 510 detect that the vehicle is stationary, measurement updates for the GPS Kalman filter 535 can utilize information relating to the vehicle static condition to improve a measurement process noise model. The navigation filter 540 generates data 555 related to position and velocity estimates to guidance based on the mixed data 523.

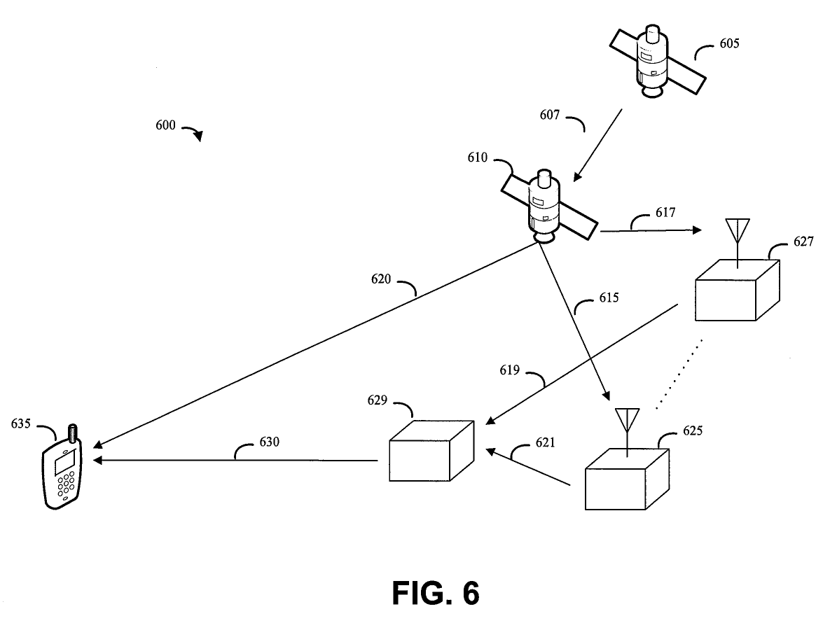

FIG. 6 is a block diagram that illustrates an embodiment of a local differential navigation system 600. An exemplary embodiment of local differential navigation system 600 may include satellite 605 (610), reference receivers 625, . . . , 627, GDGPS source 629, and GPS receiver 635. Satellite 605 corresponds to the true position of the satellite. However, due to satellite state errors 607, which include satellite orbit corrections, satellite clock corrections and ionosphere delay grid corrections, among others, satellite 610 corresponds to the broadcast position of the satellite. Although only one satellite 605 (610) is pictured in local differential navigation system 600, local differential navigation system 600 may include a plurality of satellites.

The position of the satellite is transmitted to a network of reference receivers. The network of reference receivers may include a plurality of reference receivers 625, . . . 627, corresponding to reference receiver (1) through reference receiver (n) where n is the number of reference receivers. The position of the satellite is transmitted to reference receiver 625 with transmission signal 615, to reference receiver 627 with transmission signal 617 and to GPS receiver 635 and to GPS receiver 635 with transmission signal 620. Each of transmission signals 615, 617, and 620 include errors such as an ionosphere delay. Reference receivers 625, . . . , 627 may be at known locations. In an exemplary embodiment, the known locations of reference receivers 625, . . . 627 are fixed, but may be movable in other embodiments.

The error calculations of reference receivers 625, . . . , 627 are transmitted to GDGPS source 629 with transmission signals 619, 621. The data contained on transmission signals 619 and 621 are not subject to the errors of transmission signals 615, 617, and 620. Transmission signals 619, 621 only carry data to GDGPS source 629. GDGPS source 629 is not a GPS receiver. Instead, GDPGS source is a data receiver and may include a database for storing the error calculation data sent by reference receivers 625, . . . , 627. GDGPS source 629 may also include a processor configured to calculate vector corrections based on error data received from reference receivers 625, . . . , 627. The vector corrections are sent from GDGPS source 629 to GPS device 635 with transmission signal 631. GPS device 635 receives the vector correction signal 630 from GDGPS source 629, and computes the location of GPS device 635 by using the position of the satellite received on transmission signal 620 and the vector correction signal 630.

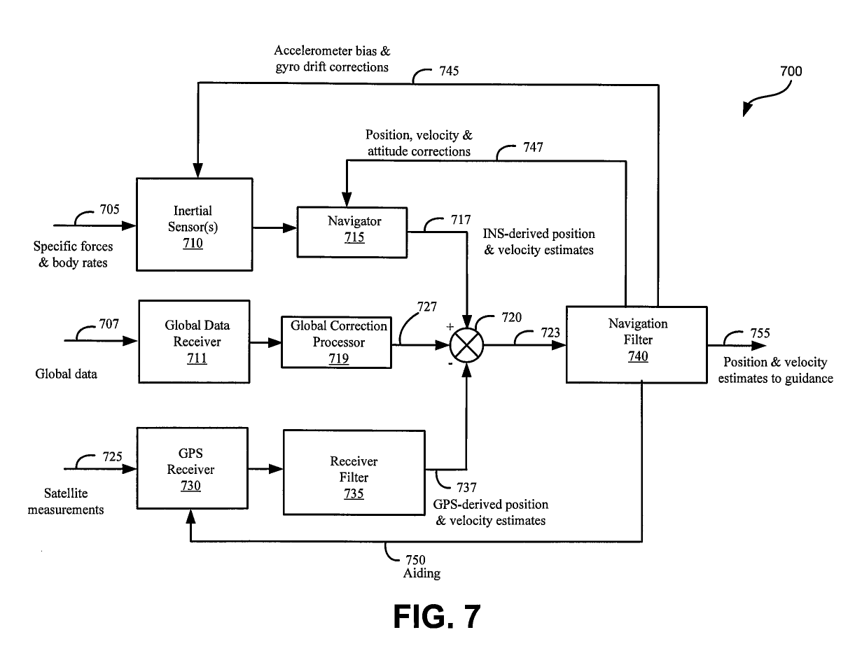

FIG. 7 is a block diagram that illustrates an embodiment of a global differential navigation receiver. The navigation receiver 700 may include inertial sensors 710 operative to detect specific forces and body rates 705. Inertial sensors 710 may include, as non-limiting examples, micro-electromechanical systems (MEMS) accelerometer, geophones and gyros, among others. The inertial sensors 710 transmit data related to the detected specific forces and body rates 705 to a navigator 715, which estimates an inertial navigational system (INS)-derived position and velocity of a vehicle based on the transmitted data. The navigator 715 transmits data 717 related to the estimated INS-derived position and velocity to a mixer 720.

Satellite measurements 725 are received by a GPS receiver 730, which transmits data related to the satellite measurements 725 to a receiver filter 735. The receiver filter 735 may include, but is not limited to, a GPS receiver Kalman filter, among others. The filter 735 estimates a GPS-derived position and velocity of the vehicle based on the satellite measurements 725, and transmits the estimated data 737 to the mixer 720.

Global correction data 707 is received by global correction data receiver 711, which transmits data related to globally measured correction data to the global correction processor 719. Global correction data 707 may include, as a non-limiting example, data from a global network of GPS reference sites, such as NASA's Global GPS Network (GGN), which is operated by the Jet Propulsion Laboratory (JPL). The data from the global network of GPS reference sites may include, as non-limiting examples, error corrections for ephemeris data, satellite clock data, and ionosphere and troposphere adjustments. These error components can be accurately estimated and cancelled using a reference receiver at a known location. However, even these nominally correlated errors lose the correlation if they are significantly delayed or are applied to receiver 711 significantly separated from the reference station. The performance of the receivers of local DGPS system 400 degrades with the distance from the local reference transmitters that transmit local error measurements 407.

The availability of a single source of DGPS corrections results in significant lowering of complexity within the receiver. DGPS using a network of various local references involves communication to the various local reference sites close to the user, handoffs among the sites as a user moves, and associated integrity issues of the local sites. In contrast, in global DGPS, the corrections are available from a single source which is independent of the location of the user, thereby reducing the spatial correlation requirements inherent in local GDPS system 400.

In an exemplary embodiment of navigation receiver 700, correction data 727 is collected by a global differential correction server, and distributed to the navigation receiver 700. In this case, global correction processor 719 may be unused and correction data 727 is supplied directly from global correction data receiver 711 to mixer 720. In one exemplary embodiment, correction data 707 is provided over the Internet. Global correction data receiver 711 may receive the data over the Internet by a wireless connection with protocols including, but not limited to, Bluetooth, IEEE 802.11, cellular telephone transmission (including CDMS, GSM, TDMA, etc.), and SMS messaging, among others. The data may also be received over a wireline connection, such as a non-limiting example of a synch cable.

The mixer 720 mixes the data 717, 727, 737 related to the INS and GPS-derived positions and velocities, and the globally corrected error data and transmits the mixed data 723 to a navigation filter 740. The navigation filter 740 may include, as a non-limiting example, a navigation Kalman filter, among others. The navigation filter 740 can generate and transmit feedback information relating to an accelerometer and gyro drift correction 745; position, velocity, and attitude corrections 747; and aiding information 750 to the inertial sensors 710, the navigator 715, and the GPS receiver 730, respectively. The inertial sensor 710 can use the information related to accelerometer and gyro drift correction for calibration of the inertial sensor 710, leading to better inertial measurement. The navigator 715 can use the information related to position, velocity, and attitude corrections for more accurate positioning, velocity, and attitude calculations.

Inertial sensor data can be used to aid the satellite signal acquisition process. The GPS receiver 730 can include code-tracking loops that can be provided with inertial sensor information to improve the ability of the GPS receiver 730 to track signals in noisy environment. Additionally, if the inertial sensors 710 detect that the vehicle is stationary, measurement updates for the GPS Kalman filter 735 can utilize information relating to the vehicle static condition to improve a measurement process noise model. The navigation filter 740 generates data 755 related to position and velocity estimates to guidance based on the mixed data 723.

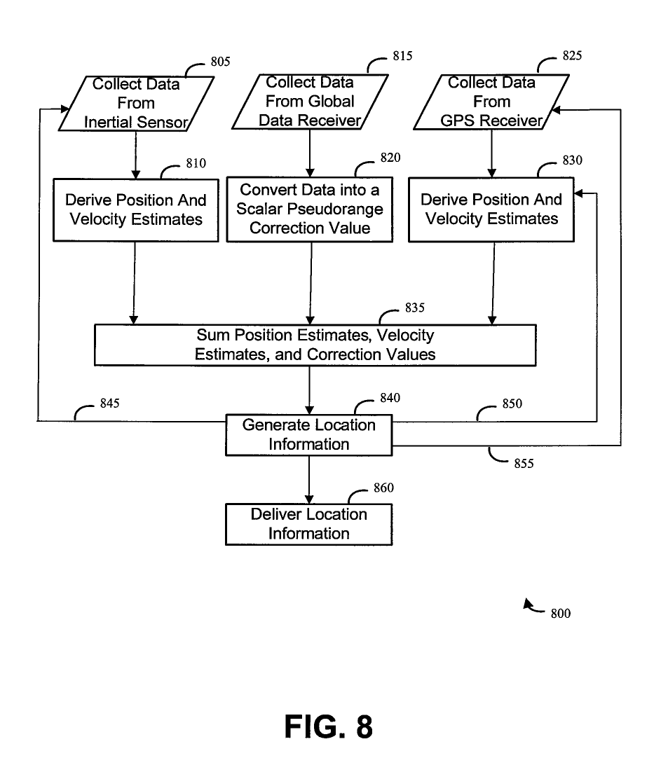

FIG. 8 is a flow diagram that illustrates an embodiment of a method 800 for GDGPS using the navigation receiver of FIG. 7. In block 805, specific forces data and body rates are collected using one or more inertial sensors. In block 810, position and velocity estimates due to movement are derived from the data from the inertial sensors. In block 825, satellite measurements are collected using a GPS receiver. In block 830, position and velocity estimates are derived from the satellite measurements. In block 815, global correction data is received from a global correction data receiver. In an exemplary embodiment the global correction data receiver may receive global correction data over the Internet. In block 820, the received global data is converted into a scalar pseudorange correction (PRC) value. In block 835, position and velocity estimates and the PRC value are summed such that location information is generated in block 840. The generated location information is fed back on path 850 to make corrections to position, velocity and attitude calculations made in step 830. The generated location information is fed back on path 855 to make corrections to accelerometer bias and gyro drift parameters that may be used in step 825. The generated location information is fed back on path 845 to make corrections to satellite measurements made in step 805. In block 860, the location information generated in block 840 is delivered for display.

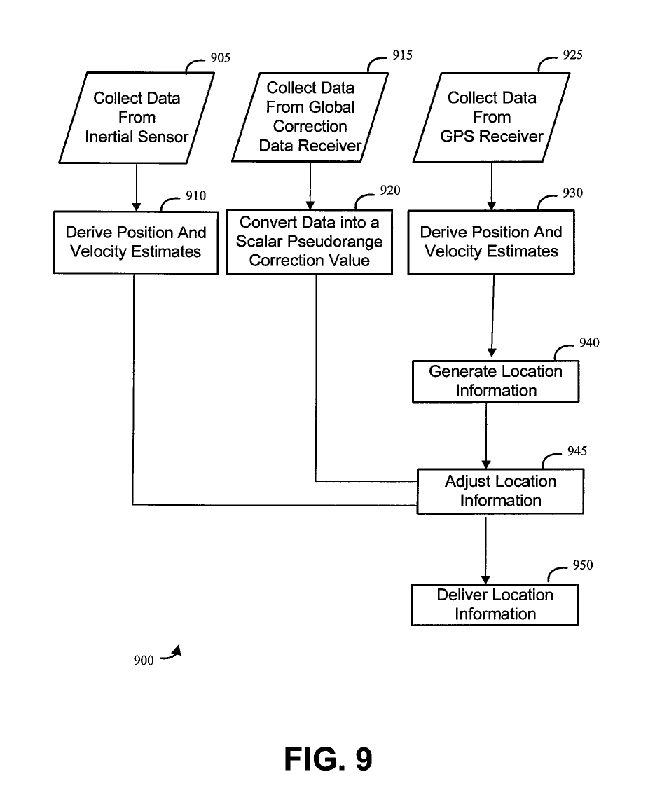

FIG. 9 is a flow diagram that illustrates an embodiment of a method 900 for GDGPS using the receiver of FIG. 7. In block 905, specific forces data and body rates are collected using one or more inertial sensors. In block 910, position and velocity estimates due to movement are derived from the data collected from the inertial sensors. In block 925, satellite measurements are collected using a GPS receiver. In block 930, position and velocity estimates are derived from the satellite measurements. In block 915, global correction data is received from a global correction data receiver. In an exemplary embodiment the global correction data receiver may receive global correction data over the Internet. In block 920, the received global data is converted into a scalar pseudorange correction (PRC) value. In block 940, the position and velocity estimates derived in block 930 are used to generate location information. In block 945 the PRC value and/or the position and velocity estimates derived from the inertial sensor is used to adjust the location information derived in block 940. In block 950, the adjusted location information generated in block 945 is delivered for display.

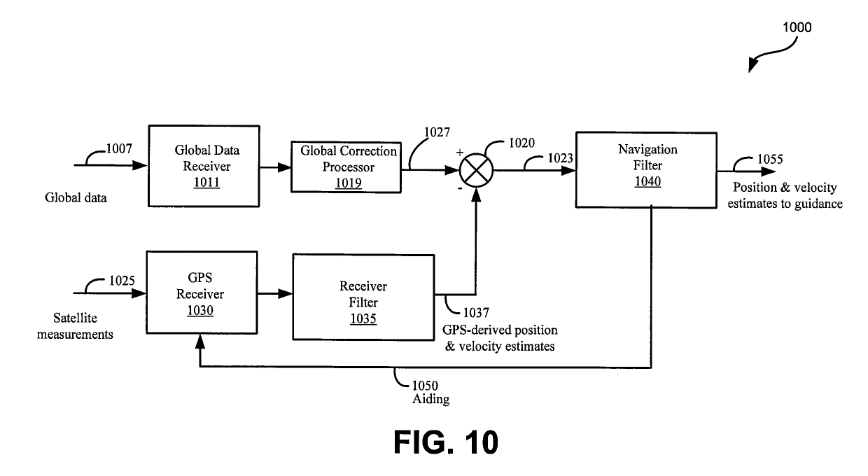

FIG. 10 is a block diagram that illustrates an embodiment of a global differential navigation receiver. Satellite measurements 1025 are received by a GPS receiver 1030, which transmits data related to the satellite measurements 1025 to a receiver filter 1035. The receiver filter 1035 may include, but is not limited to, a GPS receiver Kalman filter, among others. The filter 1035 estimates a GPS-derived position and velocity of the vehicle based on the satellite measurements 1025, and transmits the estimated data 1037 to the mixer 1020.

Global correction data 1007 is received by global correction data receiver 1011, which transmits data related to globally measured correction data to the global correction processor 1019. Global correction data 1007 may include, as a non-limiting example, data from a global network of GPS reference sites, such as NASA's Global GPS Network (GGN), which is operated by the Jet Propulsion Laboratory (JPL). The data from the global network of GPS reference sites may include, as non-limiting examples, error corrections for ephemeris data, satellite clock data, and ionosphere and troposphere adjustments. These error components can be accurately estimated and cancelled using a reference receiver at a known location. However, even these nominally correlated errors lose the correlation if they are significantly delayed or are applied to receiver 1011 significantly separated from the reference station. The performance of the receivers of local DGPS system 400 degrades with the distance from the local reference transmitters that transmit local error measurements 407.

In an exemplary embodiment of navigation receiver 1000, correction data 1027 is collected by a global differential correction server, and distributed to the navigation receiver 1000. In this case, global correction processor 1019 may be unused and correction data 1027 is supplied directly from global correction data receiver 1011 to mixer 1020. In one exemplary embodiment, correction data 1007 is provided over the Internet. Global correction data receiver 1011 may receive the data over the Internet by a wireless connection with protocols including, but not limited to, Bluetooth, IEEE 802.11, cellular telephone transmission (including CDMS, GSM, TDMA, etc.), and SMS messaging, among others. The data may also be received over a wireline connection, such as a non-limiting example of a synch cable.

The mixer 1020 mixes the data 1027 and 1037 related to the GPS-derived positions and velocities and the globally corrected error data, and transmits the mixed data 1023 to a navigation filter 1040. The navigation filter 1040 may include, as a non-limiting example, a navigation Kalman filter, among others. The navigation filter 1040 may generate and transmit feedback information relating to aiding information 1050 to the GPS receiver 1030.

The GPS receiver 1030 can include code-tracking loops that can be provided with inertial sensor information to improve the ability of the GPS receiver 1030 to track signals in noisy environment. The navigation filter 1040 generates data 1055 related to position and velocity estimates to guidance based on the mixed data 1023.

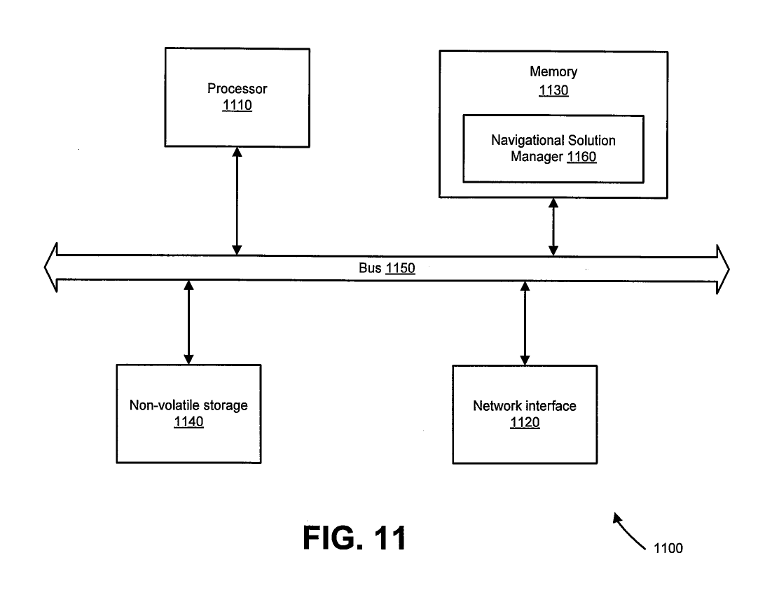

FIG. 11 is a hardware block diagram of a general-purpose computing device 1100 that can be used to implement one or more of the components of a navigation receiver, such as that shown in FIGS. 3, 5, 7, and 10. The computing device 1100 contains a number of components that are well known in the art of GPS, including a processor 1110, a network interface 1120, memory 1130, and non-volatile storage 1140. Examples of non-volatile storage include, for example, a hard disk, flash RAM, flash ROM, EEPROM, etc. These components are coupled via bus 1150. The memory 1130 may include a navigational solution manager 1160 that facilitates processing a navigational solution based on GPS measurements. The navigational manager 1160 is described in detail in relation to FIGS. 8-9. The memory 1130 contains instructions which, when executed by the processor 1110, implement at least a portion of the methods and systems disclosed herein, particularly the navigational solution manager 1060. Omitted from FIG. 11 are a number of conventional components, known to those skilled in the art that are unnecessary to explain the operation of the device 800.

The systems and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology may include (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present disclosure may include embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A navigation system comprising:
a first receiver being configured to receive global correction data from a single source; and
a computing device being configured to adjust positional estimates based on the received global correction data.

2. The navigation system as defined in claim 1, further comprising a GPS receiver being configure to receive satellite measurements from GPS satellites to generate the positional estimates.

3. The navigation system as defined in claim 1, further comprising an inertial sensor being configured to measure specific forces and body rates.

4. The navigation system as defined in claim 3, wherein the measurements of the specific forces and body rates are used by the computing device to adjust the positional estimates.

5. The navigation system as defined in claim 1, wherein the first receiver receives the global correction data over the Internet.

6. The navigation system as defined in claim 1, wherein the first receiver operates according to an IEEE802.11 protocol.

7. The navigation system as defined in claim 1, wherein the first receiver operates according to a Bluetooth protocol.

8. The navigation system as defined in claim 1, wherein the first receiver operates according to a cellular telephone protocol.

9. The navigation system as defined in claim 1, wherein the single source is maintained by the Jet Propulsion Laboratory.

10. A method for detecting location information, comprising:
receiving satellite measurement information;
receiving global correction data from a single source;
generating location information based on the received satellite information;
adjusting the location information based on the global correction data to produce adjusted location information; and
delivering the adjusted location information.

11. The method as defined in claim 10, further comprising:
receiving specific forces and body rate information; and adjusting the location information to produce inertial adjusted location information.

12. The method as defined in claim 10, wherein the global correction data is used to adjust the inertial adjusted location information.

13. The method as defined in claim 10, further comprising:
receiving specific forces and body rate information; and adjusting the adjusted location information to produce inertial adjusted location information.

14. A method for detecting location information, comprising:
receiving global correction data from a single source;
receiving position and velocity estimates from a GPS receiver;
summing the global correction data and the position and velocity estimates from the GPS receiver to produce summation data;
determining location information using the summation data; and
delivering the location information.

15. The method as defined in claim 14, further comprising:
receiving position and velocity estimates from an inertial sensor;
summing the position and velocity estimates from an inertial sensor and the summation data to produce inertial summation data; and
determining location information using the inertial summation data.

16. The method as defined in claim 14, wherein the global correction data is received over the Internet.

17. The method as defined in claim 14, wherein the global correction data is received using an IEEE802.11 protocol.

18. The method as defined in claim 14, wherein the global correction data is received using a Bluetooth protocol.

19. The method as defined in claim 14, wherein the global correction data is received using a cellular telephone protocol.

20. The method as defined in claim 14, wherein the single source is maintained by the Jet Propulsion Laboratory.
